(19) United States
(12) Patent Application Publication
(10) Pub. No.: US 2006/0280914 A1
(43) Pub. Date: Dec. 14, 2006

(54) Method and an apparatus for forming an edge thickening along a web material and a web material thus formed

(76) Inventors: Jan Jostler, Halmstad (SE); Ingermar Broden, Halmstad (SE)

Correspondence Address: SEYFARTH SHAW LLP, 131 S. DEARBORN ST., SUITE2400, CHICAGO, IL, 60603-5803, US

(21) Appl. No.: 10/569,702

(22) PCT Filed: Sep. 6, 2004
(86) PCT No.: PCT/SE04/01271

§ 371 Date: Feb. 24, 2006

(30) Foreign Application Priority Data
Sep. 4, 2003 (SE) 0302367-8

(51) Int. Cl. B32B 23/02

(52) U.S. Cl. 428/192

(57) ABSTRACT

The disclosure relates to a method and an apparatus for producing a continuous edge thickening along the running direction of a stretched and tensioned web material of a positively and continuously transported thermoplastic film material. The web material is folded initially along its outer edge regions running in the drawing direction through 180° at least once, whereafter the web material is, for the fixing of each respective fold, moved around a cylinder or roller. The folded areas are thereafter passed through a welding device in order to provide a unifying weld between the fold/folds and the remainder of the web material. With the utilisation of the residual heat stored in the fused and welded material, each respective folded and welded edge of the web is moved in its tensioned state about rollers displaying progressively reducing available roller width and with ramp formations at each respective outer edge, the folded and welded edge being plastically roll-deformed to a circular or semicircular outer cross section and a hollow inner area or section.

### FIELD OF THE INVENTION

The present invention relates to a method and an apparatus for forming and producing one or two edge thickenings along a running direction of a web or film material.

The invention also covers a web or film material thus formed.

More precisely the present invention encompasses a positively and continuously edge forming of the two side related edges related to a transported web or film material, in the form of a thermoplastic film material, and during this folding the web is preferably both stretched and tensioned.

Within the scope of the present invention falls a method and an arrangement of forming and producing one or two thickenings along each longitudinal edge of an advanced or running web or film material using the steps of folding along a folding line an edge related film portion 180° towards a centre of the film material, said centre is oriented in the advanced direction, causing an abutment or contact with a corresponding surface of the film.

In this case an elongated edge related film portion is resting towards an elongated section of the film material and forming a two-ply layer, called a “fold” in the following description.

### BACKGROUND OF THE INVENTION

In the production of packages, in the form of bags that are manufactured from a web or film material, such as a thermoplastic film, it is a common practice to supply a bag filling machine with a band exposing a number of sequentially oriented bags.

Said band of bags is produced as a semi-manufacture in the form of belts or hoses of blanks, exposing of varying degrees of completion, in order to form therefrom, utilising various punching, cutting and welding operations, belts of bags in different sizes.

The present invention discloses the production of a belt of such a semi-manufacture that needs further processing for an adaption to a content filling machine or a bag filling system.

These belts of bags are intended, in connection with the filling of the individual bag with its intended content or elements, in a first step to pass through a filling machine, in order to be filled to a predetermined degree or to the optimum level, and thereafter in a second step be sealed for a further distribution directly to or indirectly to an end user.

The present invention discloses steps for the production of a semi-manufacture in the form of a folded elongated web or film material exposing edge related thickenings, causing a stiffening of the edges, and which semi-manufacture is further processed, such as punching, welding etc., to form a number of sequentially oriented bags or pockets as a further semi-manufacture in the form of a belt construction, adapted to be used in a bag filling system.

Such a bag filling system with its filling machine is previously known to the art and is shown and described in the International Patent Application PCT/SE02/00661, published under Serial Number WO 02/083506 A1.

This bag filling system is adapted for using an apparatus for opening and closing packaging blanks or pocket formed bags of different forms, disposed along a web or film material in sequence after one another.

In FIG. 5 in this patent publication is disclosed the use of mechanical retainer means (33a, 33b), which are disposed, on the displacement of a flexible web or film material (20) along said mechanical retainer means, to guide corresponding retainer means (13a, 13b in FIG. 4a) disposed at the upper edges of said processed web or film material.

FIG. 4 discloses the use of guide members (35, 36) provided for leading or guiding the opposing walls of the web or film material from each other in order to open the formed pockets and then guide back the walls to a position adjacent one another for closing the opened pockets once the content or contents have been supplied to said pocket.

FIG. 4a shows a packing blank or pocket (26), which is suspended in a mechanical retainer means (33) with a recess or channel (31) in which the retainer means (13a, 13b) of the edge portion of the web material or pocket are located. These retainer means and the intermediate film or web material are formed simultaneously in an injection moulding process.

The lower side of said channel (31) is provided with a gap or a slot (34) with a gap width which prevents the retainer means (33) of the edge portions from passing but which permits both wall sections of the web material to pass. The pocket (26) is here shown in an unopened state.

In FIG. 4b is illustrated the pocket (26) in an opened state and the retainer means of each respective edge portion are inserted in separated channels (31a, 31b), which are located in spaced apart relationship from each other.

Each separate wall section (21a, 21b) of the web material passes through a gap or slot (34) in the lower region of the mechanical retainer means.

The gap or slot has a width that prevents the retainer means of the edge portion from passing through.

It is here obvious that each retainer means (13a, 13b) related to its upper edge portion of the web material or wall section is formed integrated with its wall section and is formed as homogeneity with its wall section.

Thus the present invention is concentrated to a method and an arrangement for folding an edge related web or film portion along a folding line in order to process this formed “fold” further, to realise a retainer means related to the web or film material and adjacent an opening of the bag or pocket

The forming of said retainer means is based on the feature that two upper edges of a bag, the edges forming an opening, are provided with stiffening or thickened portions, it has proved that access to prefabricated starting material is restrictive or defective in order to form such stiffening or thickened edge portions in optional bag and/or belt material of thermoplastic.

One alternative to specially ordering the production of bag or pocket belts provided with thickened upper edge portions could possibly be to add to said material for the bags such an edge stiffening or thickening by a welding operation or process.

Such a process has however been rejected due to the lack of flexibility and related high costs involved in such a solution.

In such instance, as regards flexibility, it has been a need to be able to produce or realise more or less completed or finished bags of different sizes, material thickness and with other properties, such as, for example, with a bottom section exposing infolds and/or with a re-closable feature, one of different types, for example so-called “sliders” (a type of a zip arrangement in plastic) or mini-grips.

One of the reasons for this is that there has always been a risk that the cost per package will be higher than necessary, because of unnecessarily high material demand or consumption, but also a risk that the desired flexibility will be poorer and, as a result, costs higher than otherwise in the event that a larger or smaller package is needed from time to time and such a package is not available, in which event the result may instead be machine downtime, which in all reasonableness in the long term naturally must be avoided.

The present invention is based upon the principle of folding an edge related web or film portion to an abutment with a corresponding (upper) surface of the film and in this respect such folding is previously known in different applications.

In addition to the prior art mentioned above, as the International Patent Application, it is also known in the patent publication EP-A1-0 063 868 an improvement in and relating to packaging material and packages formed therefrom.

To facilitate butt-welding, or “L”- or “T”-welding joints, the edges of a plastic-coated paper-layered web (1) of packaging material are thickened e.g. by folding over and sealed down edge zones.

The folding line (14) of each edge zone may be creased before folding, and the upstanding crease is enclosed between the folded edge zone and the body of the web.

The sealing of the edge zone may be effected by pressure rollers (21) holding the edge zone against a rotating cylindrical surface (22), whereby a curl or curvature is imposed upon the web.

Patent publication EP-A1-0 437 848 discloses and describes an apparatus for folding an edge (11) on a continuous material web (10), in which the continuous web (10) is caused to pass a belt (1) between two wheels (2, 3) and in which the belt (1), which is twisted through 180°, folds over the edge (11) in its twisting action.

The belt (1), which is endless, runs over further two wheels (4, 5) in order to be returned.

In patent publication EP-A2-1 095 759 there is shown and described a stretch film having thermosealed edges.

More precisely a highly stretched film (40) has permanently thermosealed edges (43) that are nearly invisible.

A folding apparatus (30) folds the edge portions of a film to form folded edges (43).

The folded film then is passed through a bridge mechanism having two heated rolls (15, 16). A series of nips (13, 17, 18) apply pressure to the folded film as it is heated by the heated rolls (15, 16).

The nip pressure, combined with the heat imparted by the heated rolls (15, 16), causes thermal welding of the folded edges resulting in permanent thermosealed edges (43).

Because the film edges are folded prior to the hot stretching, the hot stretch process performs dual functions of stretching the film and thermosealing the folded edges (43).

The resulting stretched film has permanently thermosealed edges that do not separate and which prevent tearing of the film edges during subsequent processing and use.

Patent publication FR-A1-2 569 762 also discloses a process and a device for folding edge zones of a web material.

Patent publication DE-A1-3 027 521 discloses a folding arrangement adapted for labels oriented in a band-form using a folding ring (2) arranged at a distance (A) from a unit (4) and a profile plate (3, 3′, 30) forming slots (14, 15, 15′)

Patent publication U.S. Pat. No. 4,606,784 discloses a method and an arrangement for the folding and sealing of a longitudinal edge of a material web.

In the manufacture of packing containers from laminated material, contact between the inner layer of the material and the contents is avoided by doubling up the cut edges present in the packing container.

The problem to be solved is here to perform a secure folding and sealing of the folded edge without damage to the material, since the outer, water-tight layer of the material consists of very thin, heat-sensitive, thermoplastic material.

This problem is solved by carrying out the folding and sealing of the edge of the web material gradually while at the same time supplying heat or glue.

### SUMMARY OF THE PRESENT INVENTION

Technical Problems

When the technical deliberations that a person skilled in this particular art must make in order to provide a solution to one or more of the hereinunder mentioned technical problems he/she encounters are taken into consideration it will be seen that it is initially necessary to realise the measures and/or sequence of measures that must be undertaken to this end and to realise which means is/are required.

On this basis, the technical problems listed below should be relevant to the development of the present invention.

When the prior art methods, apparatuses, arrangements and constructions, as described above, are considered it will be seen as a technical problem to realise the necessity of, the advantages related to and/or the technical measures to be undertaken in a environment where a method and an arrangement are suggested for causing an edge reinforcement of edge zones or portions by folding and processing a web or film material and to process a “fold” to form retainer means to each of the opening portions of a bag or pocket in a sequence of intended bags, formed from a folded plastic material.

It will be seen as a technical problem to realise the necessity of, the advantages related to and/or the technical measurements to be undertaken in an environment of forming retainer means related to a web or film material consisting of a semi-manufacture, which after further processing is intended to form enclosures in the form of bags or pockets and propose a method and an arrangement of forming and producing one or two thickenings along each longitudinal edge of an advanced or running web or film material using the steps of folding along a folding line an edge related film portion towards a centre of the film, said centre is oriented in the advanced direction, causing an abutment or contact with a corresponding surface of the film and propose that said edge related film portion and said corresponding surface shall be bent to or rolled in a rolling or bending sequence and in a direction of advancement to cause a loop as said thickening, where said loop is causing or forming a hollow central section or region.

It will be seen as a technical problem to realise the necessity of, the advantages related to and/or the technical measurements to be undertaken in an environment of forming retainer means related to a semi-manufacture, which after further processing is intended to form enclosures, in the form of bags or pockets, and that a heat welding is concentrated to a surface section between an edge related to said film material and said folding line.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that an increasing number of folding lines is dependent of a decreasing thickness of the film, to cause said “fold”.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that the number of folding lines related to said “fold” is chosen to two or three.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that the thickness of the film material is chosen between 15 and 100 μm, preferably between 50 and 80 μm.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that the bending or rolling of said edge related film material portion and said corresponding surface forming said “fold” is caused by a cylinder related arched-formed surface.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that the web or film material is of a plastic material and exposing a temperature, during said bending or rolling sequence, by which the material surface exposes adhesive property, whereby an edge related to said film material and said folding line causing said “fold” adheres to each other to form said loop.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and proposing an apparatus of folding longitudinal edge portions of an advanced or running thermoplastic web or film material towards an intermediate portion and sealing said edge portions to said intermediate portion using a first folding apparatus, adapted to fold and to bring said edge portions to an abutment or contact with a surface of the film material related to said intermediate portion and that a folding of said folded edge portions is caused by a second folding apparatus adapted to fold and to bring said folded edge portions to an abutment or contact with a surface of said folded edge portions caused by said first folding apparatus and sealing said doubled folded edge portions.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and producing a continuous edge thickening along a running direction of a web material of a positively and continuously transported thermoplastic film, whereby the web material is initially folded through 180° at least once along its outer edge region running in the running direction; that, after such folding, the web is, for the fixing of each respective “fold”, displaced an angle around a roller or cylinder; that each respective folded area is passed through a welding device in order to provide a unifying weld between the fold/folds and the remainder of the web material; that, utilising the residual heat stored in the fused and welded material, each respective folded and welded edge of the web material, in its tensioned state, is moved around cylinders or rollers with progressively reducing available roller width and with formations at each respective outer edge, the folded and welded edge is plastically deformed to a circular or semicircular outer cross section with a hollow central region.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that a double edge folding is applied to thermoplastic film or web materials of a material thickness of up to 80 μm, which a single edge folding preferably applied to thicker web materials.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and make use of an arrangement or an apparatus for producing at least one continuous edge thickening as a retainer means along the running direction of a web material of a positively and continuously transported thermoplastic film material, whereby said arrangement includes, a) at least one “fold” and/or guide rail per edge thickening, in order, during the initial folding of the edge of the web material transversely of the running direction at 90°, to define the width thereof on its continued transport in the longitudinal direction at an amount corresponding to the size of the inward “fold”, the fold and/or guide rails being designed, during the transport of the web material, to further fold in the web material to a total of 180° to an area of the web material located inside the “fold” under the formation of a single or double-folded portion per side of the web material, b) a welding device for mutually fusing and welding together the fold portions and these adjacent portions of the web and c) edge seaming or folding rollers, disposed subsequently in the running direction, which display progressively reducing available roller width and are provided with ramp formations at each respective outer edge in order that these, under the utilisation of residual heat which remains in the thermoplastic web or film material after the welding operation, as a result of cylinder or roller deformation of the welded edge portions, shall form edge thickenings of circular or semicircular outer cross section.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that the fold and/or guide rails include, in the running direction of the thermoplastic film, an initially somewhat downwardly and outwardly bent portion in relation to the web material, but thereafter only include flat element pieces coplanar with the web material and its “folds”, at the same time as each respective fold and/or guide rail finally, in the transport direction of the web material, displays two flat elements coplanar with the web material with a bend of 180° in relation to the flat element pieces.

It will be seen as a technical problem to realise the necessity of, the advantages related to and/or the technical measurements to be undertaken in an environment of forming retainer means related to a semi-manufacture, which after further processing is intended to form enclosures in the form of bags or pockets and that a hot air unit is disposed in immediate association to and immediately before a first edge seaming or folding roller.

Solution

The present invention has as its point of departure a method and an arrangement for forming and producing one or two thickenings along each longitudinal edge of an advanced or running web or film material using the steps of folding along a folding line an edge related film portion towards a centre of the film material, said centre being oriented in the advanced direction, causing an abutment or contact with a corresponding surface of the film material. In order to solve one or more of the above mentioned technical problems, it is suggested that said edge related film portion and said corresponding surface are bent and/or rolled in a bending or rolling sequence and in a direction of advancement to cause a loop as said thickening.

It is suggested that heat-welding is concentrated to a surface section between an edge related to said film and said folding line.

An increasing number of folding lines is dependent on a decreasing thickness of the film material and the number of folding lines is chosen to one, two or three.

Further, the thickness of the film material is chosen between 15 and 100 μm, preferably between 50-80 μm.

The bending or rolling of said edge related film portion and said corresponding surface is caused by a cylinder related arcuate surface.

It is especially suggested that the film material is of a plastic material and exposing a temperature, during said bending or rolling sequence, by which the material exposes adhesive property, whereby an edge related to said film and said folding line adhere to each other to form said loop.

More particularly, it is suggested the folding of longitudinal edge portions of an advanced or running thermoplastic web or film material towards an intermediate portion and sealing said edge portions to said intermediate portion using a first folding apparatus adapted to fold and to bring said edge portions to an abutment or contact with a surface of the film material related to said intermediate portion whereby a folding of said folded edge portions is caused by a second folding apparatus adapted to fold and to bring said folded edge portions to an abutment or contact with a surface of the folded edge portions caused by said first folding apparatus and sealing said double folded edge portions.

It is also suggested the production of a continuous edge thickening along a running direction of a web of a positively and continuously transported thermoplastic film material, whereby the web material is initially folded through 180° at least once along its outer edge region running in the running direction; that, after such folding, the web material is, for the fixing of each respective fold, displaced an angle around a roller or cylinder; that each respective folded area is passed through a welding device in order to provide a unifying weld between the fold/folds and the remainder of the web material; that, utilising the residual heat stored in the fused and welded material, each respective folded and welded edge of the web material, in its tensioned state, is moved around rollers with progressively reducing available roller width and with ramp formations at each respective outer edge, the folded and welded edge being plastically deformed to a circular or semicircular outer cross section.

It is further suggested that double edge folding is applied to a thermoplastic film or web material having a thickness of up to 80 μm, while single edge folding is applied to thicker web materials.

It is especially suggested, that within the welding operation, welding jaws are linearly reciprocal towards and away from the web material and, thermo-tolerant belts are located along the jaws and located in the longitudinal direction of the web between the jaws and the web material are moved at a speed which is equal to that of the thermoplastic web material.

The welding is executed centrally above each respective fold.

Advantages

It is an object of the present invention to suggest a method and an apparatus, which make a production of a continuous edge thickening along the longitudinal direction of a stretched and tensioned web material of a positively and continuously transported film or web material of thermoplastic, the method and the apparatus giving rise to as good as total flexibility as regards material thickness, bag size and the allocation of special properties in accordance with the foregoing.

According to the present invention, the web material is progressively folded along its outer edge regions running in the longitudinal direction, initially through 180°, at least once, whereafter the web material is, for the fixing of each respective “fold”, passed through and around a roller and each respective folded region is passed through a welding device, in order to provide a unifying weld between the fold/folds and the remainder of the web material, whereafter, utilising residual heat stored in the fused material, each respectively folded and welded edge of the web material, in its tensioned state, is passed around cylinders or rollers with progressively reducing available roller width and with ramp formations at each respective outer edge (like the one part of a grooved pulley), whereby the folded and welded edge is plastically deformed in such a manner that it is given circular or semicircular outer cross sectional configuration with a hollow interior which is well-suited for use as retainer means.

### BRIEF DESCRIPTION OF THE ACCOMPANYING DRAWINGS

The present invention will now be described in greater detail hereinbelow, with reference to one embodiment shown on the accompanying drawings. In the accompanying drawings:

FIG. 1 shows an overall view of a plant for producing a semi-manufacture band from an up-rolled and planar web or film material, with a thickness preferably about 80 μm, exposing side related stiffening means or retainer means adapted to an apparatus for opening and closing packages as shown in International Patent Application PCT/SE02/00661 (WO 02/083506 A1) where used processing units are only schematically illustrated,

FIG. 2 shows one apparatus or arrangement, left oriented in FIG. 1, of two arrangements used in accordance to the invention, in a side elevation view with disclosed cross sectional markings A-A to G-G, representing the shape of a plastic, such as thermoplastic, web or film material, as it advances through the arrangement,

FIG. 3 shows on a larger scale the cross sections A-A to G-G given in FIG. 2 through a thermoplastic foil,

FIG. 4 shows in a perspective view the apparatus according to FIG. 2,

FIG. 5 shows a lower section of the illustration in FIG. 4 on a larger scale,

FIG. 6 shows an upper section of the illustration in FIG. 4 on a larger scale,

FIG. 7 shows in a perspective view the apparatus according to FIG. 2 in a different direction compared with FIG. 4, and

FIG. 8 shows in a perspective view and in side elevations and in cross-sections one guide rail, adapted to fold an edge related film portion of the web or film material and of a type used in the arrangement or apparatus according to the invention.

### DESCRIPTION OF PREFERRED EMBODIMENT

The present invention relates to a method and to an arrangement (or apparatus) of forming and producing one or two thickenings 18, 18′ along each longitudinal edge 2a and 2b of an advanced or running web or film material 2 using the steps of folding said material 2, along a folding line 2a′ and 2b′, and an edge related film portion 2c and 2d towards a centre 2′ of the film material, said centre 2′ is oriented in the advanced direction “E”, causing an abutment or contact with a corresponding surface of the film material.

The undersides of the film portions 2c and 2d are here facing the upper side of the film material 2 and are bent or rolled to form said two thickenings 18 and 18′ serving as retainer means.

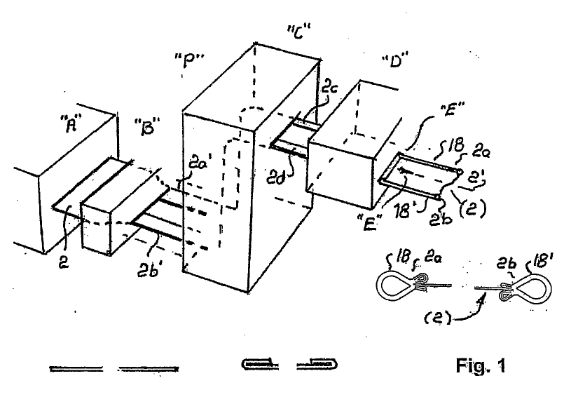

With a reference to FIG. 1 there is here shown an overall view of a plant “P” for producing a semi-manufacture (2), from a thin web of film material 2 up-rolled and planar web or film material, included in a storage “A”, by using in a sequence a folding apparatus “B”, a heat-welding arrangement “C”, and an edge bending or rolling section “D”.

In this illustrated embodiment it is suggested that the produced semi-manufactured web or film material (2) discloses properties adapted for heat-welding and given a thickness preferably about 80 μm, exposing side related stiffening means 18, 18′ or retainer means adapted to an apparatus for opening and closing packages as shown in the International Patent Application PCT/SE02/00661 (WO 02/083506 A1) where used processing units, given the reference numerals “A” to “D” are only schematically illustrated.

Said edge related film portions and said corresponding surfaces are bent or rolled in a bending or rolling sequence and in a direction of advancement “E” to cause a retainer means related loop as said thickening 18, 18′.

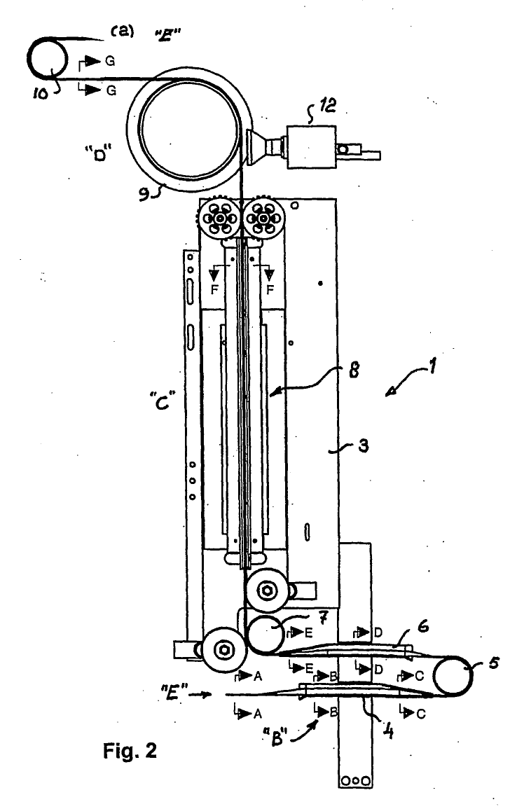

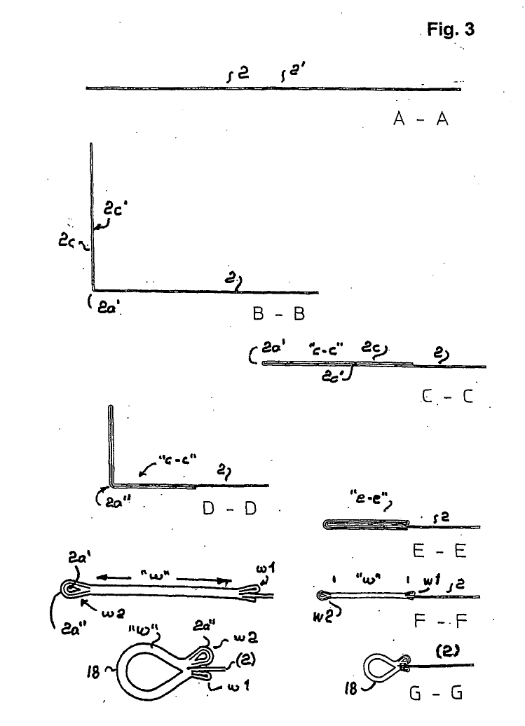

FIG. 3 shows on a larger scale the cross sections A-A to G-G given in FIG. 2 through the thermoplastic foil 2 as it advances through the plant “P”.

A stretched film material 2, shown under section A-A is folded in the folding unit or apparatus “B” in a first step along a folding line 2a′ to right angle, illustrated in section B-B and further in a second step C-C to cause a “fold”, illustrated here that the inner surface 2c′ edge related film portion 2c is in abutment with a corresponding upper surface of the film material 2.

With a thick film material 2, for instance over 80 μm, the inventive concept may be realised with a single “fold” as illustrated in section C-C by proceeding directly to the heat-welding arrangement in unit “C”, illustrated in section F-F.

With a thinner film material 2, for instance beneath 80 μm, the inventive concept may be realised with a double “fold” as illustrated by folding the fold “C-C” to the right angle in section D-D via a folding line 2a″ and further in a second step to cause a double “fold” as in section E-E, given the reference “e-e”.

A heat welding is concentrated to a surface section “w” between an edge “w1” related to said film and said folding line or additional folding line “w2”.

The invention illustrates that an increasing number of folding lines 2a′, 2a″ is dependent on a decreasing thickness of the film material however the number of folding lines is normally chosen to the illustrated two but may be three, probably not more.

The thickness of the film is chosen between 15 and 100 μm, preferably between 50-80 μm.

The bending of and the rolling of said heat-welded edge related film portion, illustrated as “w1”, “w” and “w2” illustrated in an elongated scale in section F-F and said corresponding film material related surface is caused by a cylinder related arched-formed surface as shown in G-G.

The film material 2 is of a plastic material and displaying a temperature during said bending or rolling sequence F-F to G-G by which the material displays adhesive properties, whereby an edge related to said film and said folding line adheres to each other to form said loop.

With reference to FIG. 2 it is shown, in a side elevation view, a part of the apparatus 1 according to the invention, more precisely the right-hand side thereof if the apparatus is observed in the direction (E) in which processed film material departs from the machine or plant “P”.

The FIG. 2 shows only one out of two apparatuses or arrangements, since it is observed that a film or web 2 of thermoplastic material which is transported between two units, which have identical though mirror-reversed construction.

The apparatus has a frame construction 3 (partly not shown), which entails that the different component parts of the apparatus 1 will be in mutually fixed in relation to one another such that the different parts are adjustably fixable within a smaller tolerance range.

The film or web material 2 is inserted at “E” in FIG. 2 where, after a short distance, it comes into contact with a first fold and/or guide rail 4, is passed around a roller 5 and comes into contact with an additional, a second, fold and/or guide rail 6 included in the folding apparatus “B” and is also passed around an additional roller 7.

After the roller 7, the film or web material 2 is passed through a welding zone 8 in the heat-welding arrangement “C”.

Thereafter, the folded and heat-sealed or -welded film or web material 2 is passed via a side portion folding or rolling cylinder or roller 9 in order, via a bending roller 10, to pass an additional folding roller 11 and forms a semi-manufacture (2).

Immediately before the film or web material 2 comes into contact with the folding roller 9, a hot air unit 12 is provided in order to supply additional heat to the extent the residual heat, which remains in the film or web material 2 after the welding operation within the heat-welding arrangement “C”, is insufficient for the final edge forming or merging.

FIG. 3 shows the cross sections taken through the thermoplastic film or web material 2 from the markings A-A, B-B, C-C, D-D, E-E, F-F and G-G in FIG. 2, which reflect the sequence of the folding states of the film or web material 2 in each respective cross section.

In this context, it should be particularly observed that cross section A-A marks the starting position of the film web, cross section E-E its position before the execution of a welding operation and cross section G-G a final form of an edge thickening or retainer means 18, 18′ that is produced using a method and an apparatus or arrangement according to the invention.

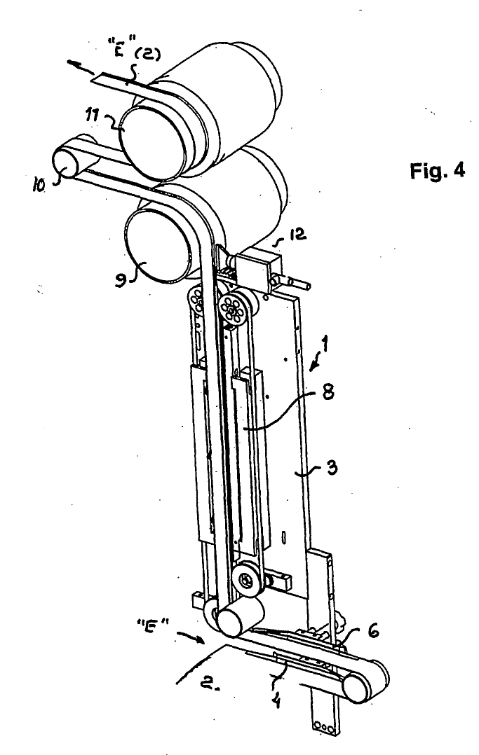

FIG. 4, which shows the apparatus 1 according to the invention as a perspective view obliquely in relation to the direction (E) in which the film or web material 2 is fed to the apparatus 1 and material (2) departs from the apparatus 1, shows with greater clarity how the different parts therein are constructed.

The frame construction 3 and the welding zone 8 are particularly clearly apparent.

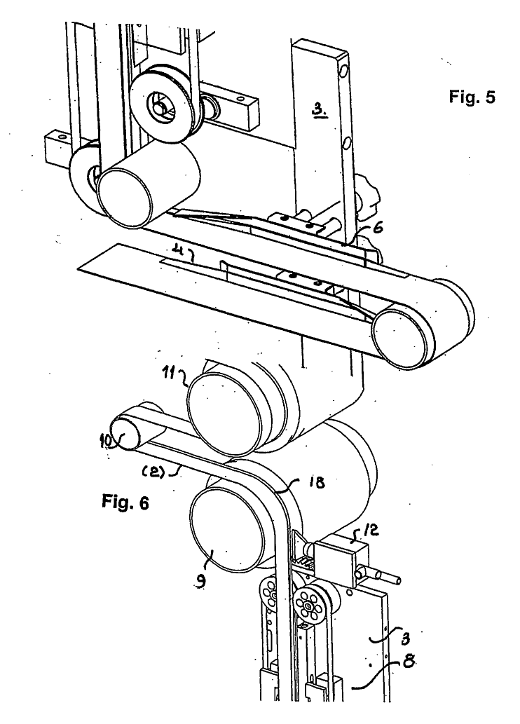

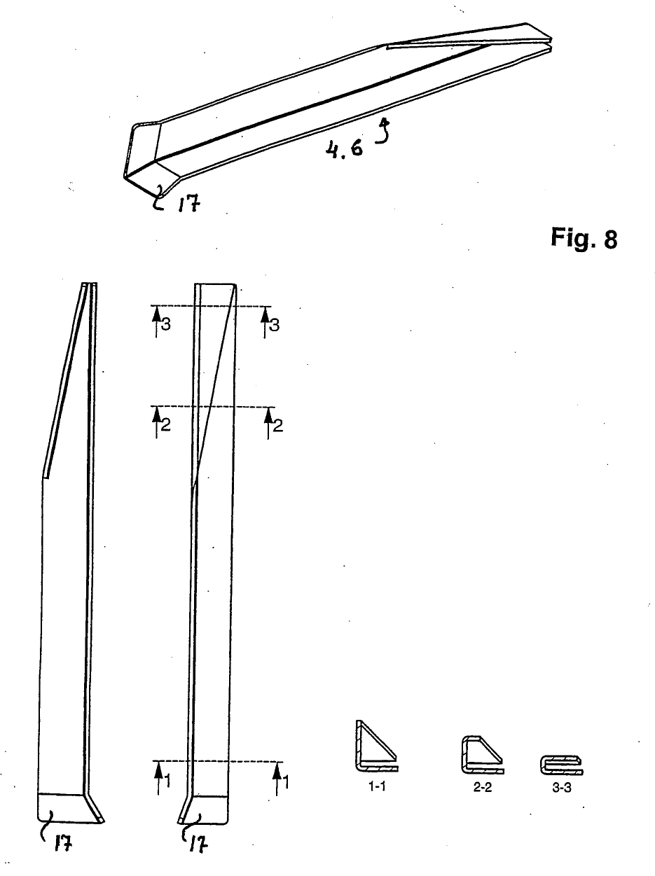

FIG. 5 shows a partially magnified or enlarged part of the lower section of FIG. 4, which shows the design (FIG. 8) and function of the fold and/or guide rails 4 and 6, respectively and the method in which they are adjustable in the lateral direction.

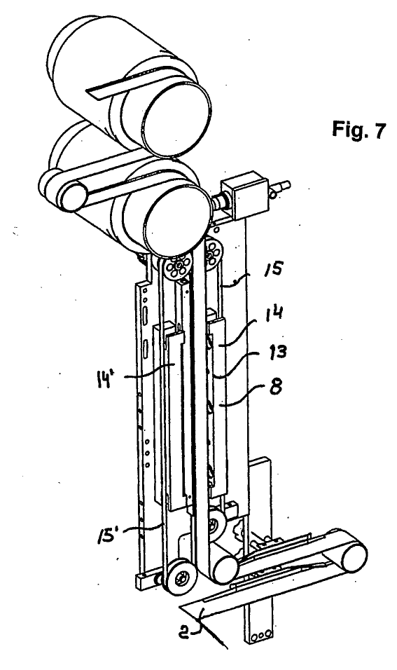

Analogous with FIG. 5, FIG. 6 shows a partially magnified or enlarged section of FIG. 4 in this case the upper section thereof, int. al. the positioning of the hot air unit 12, the construction of the welding zone 8 in principle being clearly apparent, and also how the method in which the final folding of the welded and singly or doubly folded edge zone proceeds.

FIG. 7 shows the apparatus according to the invention as a perspective view seen obliquely in that direction in which the film web 2 runs into the apparatus according to the invention. This view clearly shows int. al. the opposite side compared with FIG. 5 and FIG. 6 of the welding zone 8 and the construction of the welding device 13 included therein.

FIG. 8 shows, partly as perspective views and partly as plan views and three different cross sections from the bending and appearance of the fold and/or guide rails 4 and 6, respectively which are disposed initially to fold the edge of the film web 2 in two steps before the welding thereof.

The realisation of an edge thickening of the above-described type takes place against the background of the fact that the intention is to produce a bag blank which is suitable for handling in a bag filling machine intended for bags provided with an edge thickening.

In such a machine, the individual bags are filled in a bag blank belt at a highly accelerated tempo. The present invention satisfies a possibility, using relatively simple means, to create bags of optional size by mutual displacement of spacing (at right angles to the plane of the paper in FIG. 2) by both of the parts of the apparatus 1, identical but mirror-reversed (only one is shown) and the arrangement of the thermoplastic film or web materials of different widths therein.

The thermoplastic film or web material 2 is fed from a roller actuated by a calibrated braking moment, between which and the apparatus 1 there may be disposed pre-tensioning means, for example in the form of dancing rollers (not shown) so that the thermoplastic film or web material 2 is kept taut in a suitable manner.

In principle, a wholly planar thermoplastic film or web material 2 is fed into the apparatus at “E” from a magazine reel, which is disposed on a roller (not shown). The edge of the film or web material 2 is folded once or twice (depending on material thickness) with the aid of the fold and/or guide rails 4 and 6, respectively, with interjacent turning.

As was mentioned above, the fold and/or guide rails are shown in detail in FIG. 8 and its sections showing a guide rail 4, 6 with a transparent thermoplastic film or web material 2 as perspective view, the thermoplastic film or web material 2 intended for folding being fed in at the left-hand side thereof.

The rails 4 and 6, which consist of pressed and/or bent sheet metal, each display small outward bends 17 at the in-feed end whose purpose is to assist in the thermoplastic film or web material being able to be led into the rails 4 and 6 at high speed without difficulty.

This is apparent even more clearly from the view in the FIG. 8. Three different cross sections, which are marked by 1-1; 2-2 and 3-3, respectively are apparent from these Figures.

It will be apparent from these Figures partly the exact folding state of the film or web material 2 in each respective position and partly the design of the fold and/or guide rails in these different positions.

After initial folding as illustrated, the web material 2 is passed further into the welding zone 8, a region “w” that is located in the longitudinal direction of the thermoplastic film or web material substantially in register with the folded portions being welded and fused together in a continuous process using a welding device 13.

The welding device 13 located in the welding zone includes welding jaws 14, 14′ (FIG. 7), which are displaceable towards and away from the web material 2 and between which and the folded portions of the thermoplastic film web material 2 there are belts 15, 15′ of thermo-tolerant material (for example Teflon®-coated).

These belts 15, 15′ are moved in an infinite manner at the same speed as the thermoplastic film web material 2 along the edge on either side and both edges thereof in order, while the jaws heat and fuse together the thermoplastic film, to prevent adhesion between the jaws and the thermoplastic film or web material 2. The belts 15, 15′ are led positively and being driven by a motor (not shown) around wheels suitable for the purpose in such a manner that the belts function as infinity belts.

Thereafter, the thermoplastic film or web material 2 is led further in order, utilising residual heat stored in the web after the completion of the welding operation, to bring the edges thereof over edge rolling or folding rollers 9 and 11, respectively, of frusto-conical edge cross section, the one being narrower than the other, in order hereby to deform the edges of the thermoplastic film or web material so that an almost externally circular but hollow cross sectional configuration is realised.

However, in certain cases, the residual heat is not sufficient to make for the above-described edge rolling or folding, for which reason the feature has been added that, in the area immediately ahead of the entry into the edge rolling or folding zone “D”, there is provided a hot air unit 12 in order, as needed, to raise the temperature in the edge of the thermoplastic film or web material 2.

The thermoplastic film or web material 2 has thereby been provided with the originally intended edge thickening and may thus be utilised, after some additional processing, as a raw material in a bag filling machine of the above-mentioned type.

What is claimed is:

1. A method of forming and producing one or two thickenings along each longitudinal edge of an advanced or running film material, using the steps of folding along at least one folding line, an edge related film portion towards a centre of said film material, said centre is oriented in an advanced direction, causing an abutment or contact with a corresponding surface of the film material, whereby said edge related film portion and said corresponding surface are bent and/or rolled in a bending or rolling sequence and in a direction of advancement to cause said thickening, characterised in that the thickness of the film material is chosen between 15 and 100 μm and that said edge related film portion and said corresponding surface are bent and/or rolled in said rolling sequence to form a loop.

2. A method according to claim 1, characterised in that a heat welding is concentrated to a surface section between an edge, related to said film, and said folding line.

3. A method according to claim 1 or 2, characterised in that an increasing number of folding lines is dependent of a decreasing thickness of the film material.

4. A method according to claim 3, characterised in that the number of folding lines is chosen to two or three.

5. A method according to claim 1 or 3, characterised in that the thickness of the film material is chosen between 50-80 μm.

6. A method according to claim 1, characterised in that the rolling of said edge related film portion and said corresponding surface is caused by a cylinder related arched-formed surface.

7. A method according to claim 1, characterised in that the film material is of a plastic material and displaying a temperature during said bending or rolling sequence, by which the material displays adhesive properties, whereby an edge related to said film and said folding line adheres to each other to form said loop.

8. A method of folding longitudinal edge portions of an advanced or running thermoplastic web or film material (2) towards an intermediate portion and sealing said edge portions to said intermediate portion using a first folding apparatus (4) adapted to fold and bring said edge portions to an abutment or contact with a surface of the film related to said intermediate portion, according to any of the preceding claims 1 to 7, characterised in that a folding of said foldable edge portions is caused by a second folding apparatus (6), adapted to fold and bring said foldable edge portions to an abutment or 15 contact with a surface of the folded edge portions caused by said first folding apparatus and sealing said doubled folded edge portions.

9. A method of producing a continuous edge thickening (18) along a running direction of a web (2) of a positively and continuously transported thermoplastic film material, characterised in that the web material (2) is initially folded through 180° at least once along its outer edge region running in the running direction; that, after such folding, said web (2) is, for the fixing of each respective fold, displaced an angle around a roller or cylinder; that each respective folded area is passed through a welding device in order to provide a unifying weld between the fold/folds and the remainder of the web (2); that, utilising the residual heat stored in the fused and welded material, each respective folded and welded edge of the web, in its tensioned state, is moved around rollers (9, 11), with progressively reducing available roller width and with ramp formations at each respective outer edge, the folded and welded edge is plastically deformed to a circular or semicircular outer cross section.

10. A method as claimed in claim 1 or 7, characterised in that a double edge folding is applied to said thermoplastic film or web material, with a thickness of up to 80 μm, which single edge folding is applied to thicker webs.

11. A method as claimed in claim 1 or 2, characterised in that in the welding operation, welding jaws (14), linearly reciprocal towards and away from the web, are employed, thermo-tolerant belts (15), located along the jaws and located in the longitudinal direction of the web between the jaws and the web, are moved at a speed which is equal to that of the thermoplastic web (2).

12. A method as claimed in any of the preceding claims, characterised in that the welding is executed centrally above each respective fold.

13. An arrangement for forming and producing one or two thickenings along each longitudinal edge of an advanced or running web or film material using the steps of folding, along a folding line, an edge related film portion towards a centre of the film, said centre is oriented in the advanced direction, causing an abutment or contact with a corresponding surface of the film material, characterised in that said edge related film portion and said corresponding surface are bent or rolled by a first means in a bending or rolling sequence and in a direction of advancement to cause a loop as said thickening.

14. An arrangement according to claim 13, characterised in that a heat welding apparatus is concentrated to a surface section, oriented between an edge related to said film and said folding line.

15. An arrangement according to claim 13 or 14, characterised in that the thickness of the film is chosen between 15 and 100 μm, preferably between 50-80 μm.

16. An arrangement according to claim 13, characterised in that the rolling of said edge related film portion and said corresponding surface is caused by a cylinder related arcuate surface.

17. An arrangement according to claim 13, characterised in that the film is of a plastic material and exposing a temperature during said rolling sequence by which the material exposes adhesive property, whereby an edge related to said film, and said folding line adheres to each other to form said loop.

18. An arrangement for folding longitudinal edge portions of an advanced or running thermoplastic web or film material (2) towards an intermediate portion and sealing said edge portions to said intermediate portion using a first folding apparatus (4) adapted to fold and bring said edge portions to an abutment or contact with a surface of the film related to said intermediate portion, according to any of claims 13 to 17, characterised in that a folding of said foldable edge portions is caused by a second folding apparatus (6), adapted to fold and to bring said foldable edge portions to an abutment or contact with a surface of the folded edge portions caused by said first folding apparatus and sealing said doubled folded edge portions.

19. An arrangement for producing at least one continuous edge thickening (18) along the running direction of a web material (2), of a positively and continuously transported thermoplastic film material, characterised in that it includes, a) at least one fold and/or guide rail (4, 6) per edge thickening, in order, during the initial folding of the edge of the web material (2) transversely of the running direction at 90°, to define the width thereof on its continued transport in the longitudinal direction at an amount corresponding to the size of the inward fold, the fold and/or guide rails (4, 6) being designed, during the transport of the web material (2), to further fold in the web to a total of 180° to an area of the web located inside the fold under the formation of a single or double-folded portion per side of the web material (2), b) a welding device (13) for mutually fusing and welding together the fold portions and these adjacent portions of the web material (2) and c) edge seaming or folding rollers (9, 11) disposed subsequently in the running direction which display progressively reducing available roller width and are provided with ramp formations at each respective outer edge in order that these, under the utilisation of residual heat, which remains in the thermoplastic web material after the welding operation as a result of roller deformation of the welded edge portions, shall form edge thickenings of circular or semicircular outer cross section.

20. An arrangement as claimed in claim 19, characterised in that the fold and/or guide rails (4, 6) include, in the running direction of the thermoplastic film material, an initially somewhat downwardly and outwardly bent portion in relation to the web material, but thereafter only include flat element pieces coplanar with the web and its folds, at the same time as each respective fold and/or guide rail (4, 6), finally in the transport direction of the web material, displays two flat elements coplanar with the web with a bend of 180° in relation to the flat element pieces.

21. An arrangement as claimed in any of claims 19 or 20, characterised in that means for fusing and welding together of the folded portions with the rest of the web include heated jaws (14) disposed on either side of the web and which are positively displaceable to and away from the web material (2) separated therefrom by thermo-tolerant endless belts (15) disposed on rollers and whose speed in operation is controlled to correspond to that of the thermoplastic film or web material (2).

22. An arrangement as claimed in any of claims 13 to 21, characterised in that a hot air unit (12) is disposed in immediate association to and immediately before the first edge seaming or folding roller (11).

23. A web and film material formed by a method according to any of the preceding claims 1 to 12.

24. A web or film material having edge related thickenings in the form of loops.
